(19) United States
(12) Patent Application Publication
(10) Pub. No.: US 2018/0082029 A1
(43) Pub. Date: Mar. 22, 2018

(54) METHODS AND SYSTEMS FOR SELECTIVELY PROVIDING INFORMATION TO A TARGETED COMMUNITY OF PEOPLE

(71) Applicant: STEVANATO GROUP S.P.A., Padova (IT)

(72) Inventor: Christophe BUREAU, Grenoble (FR)

(73) Assignee: STEVANATO GROUP S.P.A., Padova (IT)

(21) Appl. No.: 15/556,149

(22) PCT Filed: Mar. 3, 2016
(86) PCT No.: PCT/EP2016/054522

§ 371 Date: Sep. 6, 2017

(30) Foreign Application Priority Data
Mar. 6, 2015 (US) 62129055

(51) Int. Cl. G06F 19/00; G06F 17/30; G06Q 30/00

(52) U.S. Cl. CPC G06F 19/324; G06Q 30/016; G06F 17/30879

(57) ABSTRACT

Selectively providing information to a targeted community of people by choosing the community to have at least two persons; identifying a product accessed by said community having at least two product units. Then providing at least one unique product identifier for each product; providing a database having sets of information with at least two different units of information; and linking at least one set of information to each unique product identifier. Further assigning each person to at least one group, defining at least two groups; and providing each person with a reader to read said unique product identifier The reader has a request system accessing sets of information based on unique product identifiers. The reader also has a request system having a specific group identifier based on a membership to at least one group and at least one of said information units is selectively provided to said person based on said unique product identifier and said specific group identifier.

### CROSS-REFERENCE TO RELATED APPLICATIONS

This is a U.S. national phase application under 35 U.S.C. § 371 of International Patent Application No. PCT/EP2016/054522, filed Mar. 3, 2016, and claims benefit of priority to U.S. Provisional Application No. 62/129,055, filed Mar. 6, 2015. The entire contents of these applications are hereby incorporated by reference.

### FIELD OF THE INVENTION

The present invention relates to methods and systems for selectively providing information to a targeted community of people.

In particular the present invention relates to methods and systems for selectively providing information to a community of people linked through the contact with specific products. The methods and systems of the invention thereby selectively provide information to subgroups in the community without the need to specifically identifying an individual user.

### BACKGROUND

Communicating specifically with a targeted group of people, be it for the purpose of advertising, e.g. with people having dry skin, people with brown hair or people with babies, be it for medical reasons, e.g. with people having a specific disease, such as diabetes patients, with caregivers, with doctors or health services providers or be it for any other purpose has always been of considerable interest.

General channels of communication like TV, radio, newspapers and magazines, e-mails, or text messages offer the advantage of a large diffusion, but tend to be very unspecific. This lack of specificity often leads to the fact that the message, which for example in the case of a product recall can be very important is ignored and lost in the general noise of unspecific advertising. Despite the appearance of an increasing number of cable and internet TV and radio channels, of specialized newspapers and magazines, which allow for a somewhat more specific targeting of given segments of the population, these means are still too unspecific for a genuinely targeted communication of information to a community.

Social media is filling this need to some extent by gathering communities of people as per their centers or interests or needs. It is estimated today that ca. 25% of the worldwide population—on average—is connecting to a social network at least once a month. This figure though dissimulates high disparities. Details reveal for example that more than 50% of these 25% are located in Asia-Pacific. Furthermore these statistics relate to an average once a month usage, and the statistics drop steeply when considering a weekly or daily use. In addition these means of communication still rely on the fact that the targeted audience joins the relevant social media groups or makes the correct entries into the relevant user profiles. In case of medical issues the latter often being unlikely as many people prefer not to communicate medical issues with the wider community.

In particular in cases of an emergency, like the recall of a food product or a pharmaceutical product, no channel is readily available to reach out to the appropriate target group. Instead companies and the authorities usually rely on general channels of communication, such as newspaper or television announcements or websites listing products under recall.

The difficulty to reach target groups is even higher when it comes to target groups within professional organizations, often people that have no specific physical or behavioural characteristics compared to the general population, except that they have a specific field of interest. These can be for example caregivers, such as nurses, private carers and family members. While these groups of people have a different status, they usually have the same objectives in terms of safety and support to patients. Similarly, members of supply and value chains and other functions in different companies also often form a professional community. While such communities again often have their own blogs and social networks, the success of using these channels to selectively provide targeted information to members of such communities is on average similar to that described for the general population.

When it comes to the communication between groups of people who have distant positions in their value chain no dedicated channel of communication exists. For example issues related to counterfeiting demonstrate that the awareness as to the genuine character of products, or lack thereof, is often an “after-the-fact” matter. There is no simple channel for a consumer, at the end of the chain, to relate to the manufacturing entity and get first hand information on manufacturing certification.

These examples, which are by no means exhaustive, demonstrate clearly that a strong need for new communication channels exists by which targeted groups of people can be easily and specifically reached.

The present inventors have now observed that although various communities may not be reached by advertisement, they are often linked by specific products, be it moisturizing cream for people with dry skin, infant formula for parents of babies or insulin cartridges for diabetes patients. Furthermore these products form a line of communication along the value chain starting from as far back as the manufacture of the primary container for example of a drug product. One linking factor thereby is that the communities will be exposed to the packaging of the products they manufacture, sell, use, consume or otherwise come into contact with.

Indeed, although the sub-groups of people in a given community may have very different professional occupations or social statuses, they can easily be gathered in a community around the use of a single product. An example for such a community is the community of people defined by an insulin cartridge. This community may contain:
People involved in the manufacturing and packaging of the empty cartridge
People in pharmaceutical companies involved in the manufacture of the insulin and the filling thereof into the cartridge, its final packaging (primary, secondary and above) and validation People in the distribution channels from the pharmaceutical companies to the pharmacies
Doctors making the prescription of insulin to the patient
Dispensing pharmacies
Patients involved in the procurement of the cartridges as per their prescription
Payers and coaching program companies
Patients and/or nurses performing the injection
Suppliers specialized in special waste disposal.

In the context of the present invention reference is made to a “product”. This term is use to refer to an item or a combination of several items that is commonly used or accessed by a selected community of people in relation for example to: their health condition (e.g. an insulin cartridge or an insulin vial or a pen, for patients having diabetes and taking insulin, a prefilled syringe or an auto-injector for patients having multiple sclerosis or rheumatoid arthritis or an epinephrine autoinjector (EpiPen, AuviO) for people suffering from severe allergic reactions) their habits or lifestyle (e.g. sports shoes or dietary supplements for people practicing fitness; or infant formula for parents having babies or small children) their professional occupation (e.g. stent boxes for nurses assisting cardiologists and cardiologists themselves, pens or insulin cartridges for nurses assisting diabetic patients, prefilled syringes for nurses or doctors performing immunisations)

This list is merely meant as an example and is by no means exhaustive but demonstrates that a given product can be used to define communities of people coming into contact with said product, regardless of other characteristics (e.g. location, demographic, professional position) of people in that community.

The term product may thereby refer to a generic item or a specific item such as for example a product made by a specific manufacturer or a product sold under a specific brand or product name.

Furthermore the expression “product” as used herein refers to the product in all stages of its lifecycle from the initial manufacture of the product, or in some cases such as vials for injection the manufacture of the primary container to the refuse left over after the product has been used up.

As mentioned above, the uniting feature of the people in one given target group rests in the fact that they are accessing the same product, i.e. they handle this product for whatever reason (manufacture, transportation, buying, selling, use, disposal etc.). Therefore this product can be used as a useful mean of communication with members of the target group or groups of people within the target group.

While there have been attempts to use the packaging for communicating with an audience, in particular with respect to advertisements, customer loyalty schemes and competitions the uses so far require the user to log onto a specific web-site or web-service and create a specific profile for himself.

One such system is for example described in US 2014/0019606.

These systems though have several drawbacks.

First of all they rely on the user to create a profile with the respective web-site or web-service, something that in an age of increased concern about the protection of personal data has become increasingly difficult. This especially if the system furthermore relies on the entry of a correct set of data as often users input incorrect data be it out of negligence or in order not divulge data they consider personal and sensitive.

This problem exacerbated if the targeted group is in any way linked by a common medical problem as such people generally are even less likely to divulge such information online. Furthermore in some countries such practices are totally prohibited when relating to healthcare issues. In addition a link between a condition of a specific patient and any type of medical advice would in many countries be considered as a medical diagnostic tool, and would likely necessitate the regulatory approval for the packaging and its virtual content.

### SUMMARY

The present inventors have now discovered that within the above described communities there exist sub-groups and that these groups can be identified and targeted with specific information based on the way the different sub-groups interact with tags on packaging. Different groups can be assigned different readers for tags applied to the packaging and these readers identify the user as belonging to at least one specific sub-group and provide specific information based on the membership to a certain group.

This has the advantage that there is no need for the user to log onto a specific web-site or web-service. Furthermore unless the user wants and specifically agrees to it there is no identification of a specific user and therefore no issues in respect to the divulgence of personal and sensitive data or the classification of the packaging and the virtual content as diagnostics.

According to one aspect of the invention there is provided a method for selectively providing information to a targeted community of people, comprising the steps of:

a.) choosing a community of people, the community of people comprising at least two persons;
b.) identifying a product accessed by the community of people, the product comprising at least two product units;
c.) providing at least one unique product identifier for each of the product units;
d.) providing a database, the database comprising sets of information, the sets of information comprising at least two different units of information;
e.) linking at least one of the sets of information to each of the unique product identifiers;
f.) assigning each person in the community of people to at least one group to define at least two groups;
g.) providing each person with a reader, the reader being able to read the unique product identifier and comprising a request system for accessing the sets of information stored in the database based on the unique product identifier; wherein each person is provided with a reader comprising a request system having a specific group identifier based on a membership to the at least one group and wherein at least one of the units of information is selectively provided to the person based on the unique product identifier and the specific group identifier.

While the individual steps in the method of the invention are displayed in a certain order and labelled a.) to g.) this is merely meant to identify individual steps and there is no need to perform the steps in the order given. In the method of the invention the various steps can be performed in a different order without departing from the spirit of the invention.

In another aspect of the invention there is provided a system for selectively providing information to a targeted community of people, the system comprising,
at least one product the product comprising at least two product units, each of the product units being provided with at least one unique product identifier;
a database, the database comprising sets of information, the sets of information comprising at least two different units of information, at least one of the sets of information being linked to each of the unique product identifiers;
at least two readers, the readers being able to read the unique product identifier and comprising a request system for accessing the sets of information stored in the database based on the unique product identifier, wherein each reader comprises a request system having a specific group identifier based on a membership of a user to at least one group of at least two groups and wherein at least one of the units of information is selectively provided to the reader based on the unique product identifier and the specific group identifier.
   In some aspects of the invention the database in stored on a computer system and in particular on a cloud system.

Several types of data communication technologies can be used to attach the unique product identifier to a product. Examples for such technologies include for example coding tags such as barcodes, QR codes, Zapcodes, Datamatrix codes and NFC or RFID tags. Such tags require a digital reader—either optical or radio—so that their content can be read and interpreted. In some embodiments the tag might be incorporated into the product or packaging or might be the product or packaging or at least part of the product or packaging itself. In this case the tag can be read using image recognition software. These tags require an active intervention by the person willing to have access to the information contained in the tag, via some specific reader. Their inclusion in the product (or its packaging) though does not require any extra source of energy, which makes them highly miniaturisable, and usually low cost.

Other examples for useful tags include miniaturised active wireless devices that can secure autonomous communication with any pre-existing wireless network. These technologies require little to no intervention from the person holding the product (or its packaging) but require a source of energy (e.g. a battery) which makes them less miniaturizable, and usually considerably more expensive than “passive” technologies. Examples for such active tags include devices utilising SIM cards, Bluetooth, Zigbee or WiFi connectivity.

Devices using SIM cards have the advantage of full autonomy to communicate as soon as a mobile phone network is available. This is the basis for the Internet of Things (IoT) in which objects can communicate between themselves via Machine-to-Machine (M2M) protocols Bluetooth, Zigbee or WiFi based devices have short range communication capabilities and must access a hub to relay the information onto the internet. The hub in turn can be a mobile phone. In due to their size, cost and simplicity in some cases coding tags can be preferred.

In some aspects of the invention the unique product identifier is provided in the form of at least one tag selected from the group consisting of barcodes, QR codes, Datamatrix codes, Zapcodes, RFID tags and NFC tags.

In some aspects of the invention the unique product identifier is incorporated into the packaging or product or is formed by at least a part of the packaging or product.

The unique product identifier will be attached to or part of the product itself or at least one part of its packaging, such as the primary packaging (e.g. a container for a liquid product or a product in powder form), the secondary packaging (e.g. a box for the primary packaging) or the tertiary or higher order packaging (boxes in which several units of product are combined, for example for distribution). In general the unique product identifier will be attached to at least one of the primary packaging and the secondary packaging. In case the unique product identifier is attached to the tertiary or higher order packaging it can be included in a list accessible under a higher order lot identifier including several unique product identifiers. In the latter case it is generally either necessary to additionally provide a link between the unique product identifier and the individual product or to provide an additional unique product identifier on the lower order packaging. In some cases though it can be sufficient to provide the lot identifier to the method/system of the invention. In this case the lot identifier becomes the unique product identifier. If the unique product identifier is provided on several layers of packaging it can be in the same form for all levels or in different forms for different levels, for example if some forms of the identifier are more suitable to certain types of packaging or if the people coming into contact with specific levels of packaging tend to use specific scanners (e.g. in the case of high level packaging which tends to be handled almost exclusively by the distributors).

In some aspects of the invention the unique product identifier is attached to multiple levels of packaging up to and including all levels of packaging.

The expression reader relates to any device that can read the unique product identifier, communicate the unique product identifier together with the specific group identifier to the database and receive and communicate the at least one unit of information selectively received from the database to the user.

Examples of electronic devices that can read tags such as barcodes, QR codes, Datamatrix codes or any other type of tags or images that can serve as trackers, i.e. can be interpreted as digital information are generally known. Such devices include dedicated barcode scanners such as those used in shops, warehouses or logistics environments. Such scanners usually have some sort of internet connectivity be it by cable, WiFi or mobile telephony or data links. Other devices that can be used include both stationary and mobile computers with a suitable reader such as a scanner or a camera or mobile telephones or tablets, again with a suitable reader such as a camera or scanner.

The reader further has a request system for accessing the sets of information stored in the database based on the unique product identifier and the specific group identifier. The access to the database can take place by any means known to a person skilled in the art and will most likely take place using a data connection such as a wired WAN or LAN connection, a WiFi connection or a mobile telephony or data connection. It is nevertheless possible to use other means of access such as landline telephone connections, other wireless connections such as Bluetooth or dedicated radio networks or dedicated wired connections.

In some cases the hardware of the reader, e.g. in the form of a mobile phone or a computer is already present with the user. In this case the reader of the method/system of the invention is provided by installing the request system usually in the form of a piece of software.

In some aspects of the invention the reader is selected from the group consisting of barcode scanners, camera equipped computers, scanner equipped computers, camera equipped PDAs, scanner equipped PDAs, camera equipped mobile telephones and scanner equipped mobile telephones.

In some aspects of the invention the reader is a smartphone, in particular a smartphone with a camera, especially a smartphone with the capability to connect to the internet.

In some aspects of the invention the request system is an application running on a smartphone.

In some aspects of the invention the reader is a camera connected to a computer.

In some aspects of the invention the reader is a scanner (for example a manual scanner) connected to a screen (through a wire or wirelessly).

The specific group identifier in general will be a code or a software, hardware or firmware token identifying the users membership to a specific group. It is thereby perfectly possible for members of different groups to have readers consisting of the same hardware but running different software or even to have readers consisting of the same hardware having the same software. In the latter case the difference is that the software is equipped with different specific group identifiers or at least different flags or options are set identifying the user as belonging to a specific group. In any case the identification of the user as belonging to a certain group thereby is automatic and does not require any intervention from the user. It is even possible that in some scenarios the user is not even aware that the information is specific to his position in the value chain or chain of use. In some cases specific group identifiers may require a pre-authorisation or are only available to certain groups, for example for groups in the medical profession.

One of the important points for the method/system of the invention is that the specific group identifier does not identify an individual user but merely that the user belongs to a specific group. While it is possible to further give the user the option to register more specific details for example to take part in loyalty schemes or to obtain a more personalized service this is merely an option and not mandatory for the invention. Since there is no need to register the individual readers within the system the privacy of the individual user remains protected if he so wishes as neither the user nor the number of users in a given group are registered in the system unless the user does so. Although in most cases each group will contain at least two persons a user's identity is protected even if the group only contains only one member as no user identification needs to be transmitted and the number of users per group is not registered. The system will not even be able to tell if two product units were accessed by the same user or two different users unless the user explicitly agrees to share this information.

In some aspects of the invention different groups are associated with different points in the value chain of the product. For example groups can be defined for manufacturers of the product, of some or all of the packaging, the various levels of the distribution network (e.g. wholesalers, intermediates and retailers), users or people involved with disposing the refuse left after the use of the product.

It is possible that a user of the system belongs to several groups, for example if a person is involved both in the manufacture and the use of a product. In these cases the person will have different specific group identifiers for different situations or environments. If a person belongs to different groups they may have different readers, for example a scanner at the workplace and a smartphone for private use or one reader for example running different software for work or home use or the same software providing different units of information e.g. based on a user input or location services.

In some aspects of the invention the product is selected from the group consisting of medical devices, drug products, personal care products, nutritional supplements, nutraceuticals, functional foods and foodstuffs.

In some aspects of the invention at least one group consists of persons suffering from a disease or disorder. Such a disorder can for example be a chronic or non-chronic disorder.

The units of information supplied to the user can for example include data used in the tracking and tracing of goods such as GS 1 data including but not limited to identification number, lot number, expiry date; digital content or links thereto associated with the product, for example an image, a video clip or an Augmented Reality (AR) sequence, i.e. a special virtual environment appearing on the screen of the device, but also more dynamic information such as stocks of a product in a local shop or pharmacy or information on product recalls. In another embodiment, the information may be interactive, e.g. a game to be played by the user.

An example for various groups and specific information provided to them can be given in relation to a product in the form of an insulin cartridge. Such a product thereby may come into contact with the following groups:

People involved in the manufacturing and packaging of the empty cartridge. This group may be interested in checking the conformity of the procurement and incoming specifications of the raw materials or components with which the product is about to be made People in pharmaceutical companies involved in the filling of the cartridge with insulin and its final packaging (primary, secondary and above). This group may be interested to validate the quality control parameters attached to the product, such as its dimensions, composition, absence of defects as provided by the manufacturing and packaging step People in the distribution channels from the pharmaceutical companies to the pharmacies. This group may be interested in following in real time the location of the product.

Doctors making the prescription of insulin to the patient. This group may be interested to check in real time the availability of stocks of the product for the patient to be able to procure the desired product in compliance with the prescription, to check the compatibility of the prescription with the patient's condition, as well as to check the fact that product is not counterfeited and can be used in case they themselves store the product at their premises.

Pharmacists dispensing the insulin to the patient. This group may be interested in checking delivery times for new stock in case their stock is running low, as well as to check the fact that product is not counterfeited and can be used in case they themselves store the product at their premises. Furthermore this group might be interested in information on the correct administration of the insulin as well as tips on the supporting treatment or other products that might be of interest to the patient, for example products to alleviate problems and comorbidities associated with diabetes, to enable the pharmacist to make recommendations.

Patients and/or nurses performing the injection may be interested to check that the product is not counterfeited and can be used (not under recall), or else to have some educational material to facilitate the administration procedure and increase the vigilance and safety.

Due to the method/system of the invention it can be ensured that the members of the respective groups only receive the information that's relevant and useful for them. Furthermore the method/system of the invention simplifies the targeted provision of important information, such as for example about a product recall, to specific target audiences.

### BRIEF DESCRIPTION OF THE DRAWINGS

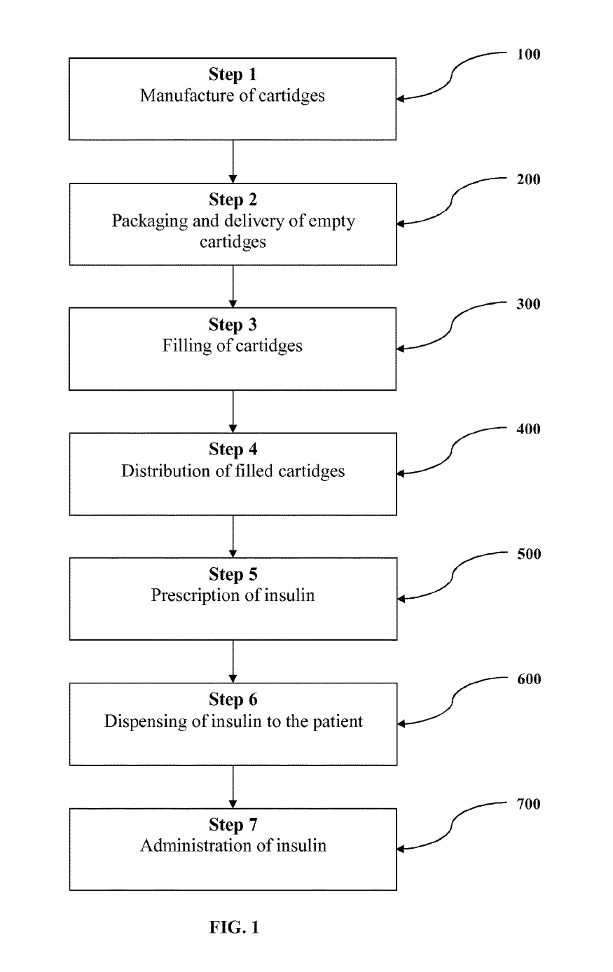

The invention will now be illustrated in more detail based on a select example and taking reference to the enclosed drawing in which FIG. 1 shows a shows a block diagram illustrating the method/system of the invention using an insulin cartridge as the linking product

### DETAILED DESCRIPTION

Reference will now be made to preferred embodiments of the invention based on specific examples and taking reference to the enclosed drawings.

FIG. 1 shows a block diagram illustrating the use of the method/system of the invention using an insulin cartridge as an example.

In step one (100) the cartridge is tagged with the unique product identifier as soon as it is formed (from a glass tube), in the manufacturing plant. In this case a barcode is etched into the glass using a laser. In a database situated in a cloud-based system an entry is created for this single cartridge. This entry, in addition to the unique identifier this entry contains further units of information such as the flame temperature at which the cartridge was formed. The cartridge then passes through the inspection and the control parameters (e.g. dimensions, defect detection etc.) are added to the respective database entry In step two (200) several cartridges are packaged into a box. This box again is tagged with an identifier code. The identifier code of this box is added to the respective database entry for each cartridge. Alternatively or in addition a further database entry can be generated containing the identifier code of the box as well as a list of the tag numbers of all cartridges it contains. The same procedure applies for any packaging collecting several cartridge boxes together for example for logistics reasons. Finally the packages containing the cartridges and their various levels of packaging are collected on a palette for their delivery to the pharmaceutical manufacturer for filling. Again these different levels of packaging are provided with respective identifier codes.

In step three (300) the cartridges are delivered to the pharmaceutical company, involved in filling the cartridges with insulin and the final packaging (primary, secondary and above). This is the first step in which the tag of each cartridge is read, in this case using a barcode scanner. The request system of the barcode scanner automatically identifies the users as employees of the pharmaceutical company involved in the filling of the cartridges. The request system requests the relevant units of information from the database based on the unique product identifiers of the individual cartridges and the specific group identifier. Based on this the users have access to the manufacturing parameters of each cartridge and can validate that each cartridge is non-counterfeit and fulfills the desired parameters before it enters their filling line. Each filled cartridge is then checked via an inspection system with the results of the filling and inspection added to the respective database entry for each cartridge. Data added in this step can for example include batch numbers and possibly manufacturer for the insulin used, date and time of filling and the results of the quality control. It is furthermore possible to add an entry that can be used for product tracking to validate that the cartridge is an original and not counterfeit. The cartridges are then packaged, and each secondary packaging is provided again either with the unique product identifier (in case the secondary packaging contains only a single cartridge) or a second identifier linked to all cartridges in the packaging. In this case a QR-code is used to tag the secondary packaging. Finally the secondary packages are again collected in larger lots which are again provided with respective identifier codes in analogy to the packaging in step two.

In step four (400) the cartridges pass through the distribution network. Here usually the tags of the higher level packagings (palette or box) are scanned and the GPS location of the packaging can be added to the respective database entry for each cartridge to validate in real time where the packaging is located. Furthermore depending on the level in the supply chain a user can be provided with information about the location and stock of further cartridges in order to adapt the deliveries to the supply or demand situation to for example route deliveries to locations with an increase in demand or dwindling stock or to order more cartridges if stocks lower down the supply chain are running low.

In step five (500) the doctor prescribes the insulin to the patient. Doctors can thereby download a specific “Doctor-App” on their smartphone. In this case the smartphone acts as the reader and the “Doctor-App” as the request system. In some cases it might be advisable that the access to the “Doctor-App” is restricted to members of the medical profession for reasons of safety. Upon scanning the unique product identifier for example on the packaging, the App sends a query to the database. The “Doctor-App” then provides the practitioner for example with information on the location of the prescribed cartridges, whether the product is available in stock and where and whether there are any outstanding product recalls. Furthermore the “Doctor-App” can check the genuine character of any cartridge in the stock kept at the practitioner's surgery. Optionally the “Doctor-App” can provide information about recent developments in the field of diabetes care as well as ways of supporting the treatment through diet and lifestyle.

In step six (600) the insulin is picked up by patients and/or caregivers at the pharmacy. In this case the unique product identifier is read by a scanner integrated in the till system. The till system in turn acts the request system and identifies the reader as belonging to the pharmacist group. In response to the request sent by the request system the database will provide information on the genuine character of the product and if there are any outstanding product recalls, as well as delivery times in case new stock needs to be ordered. In one scenario the system can give the pharmacists the option to directly order further stock if his own supplies are running low. The database can also provide information on the correct administration of the insulin as well as tips on the supporting treatment. Furthermore the database can provide information on other products that might be of interest to the customer, for example products to alleviate problems and comorbidities associated with diabetes, to enable the pharmacist to make recommendations.

In step seven (700) the insulin has reached the patient or caregiver ready for administration. The patient or caregiver can download a specific “Patient-App” or “Caregiver-App” on their smartphone. These Apps can even be the same basic App as the “Doctor-App” but with a different group identifier in order to identify the user as a patient or caregiver. The term caregiver covers every person other than the patient who helps the patient to administer the insulin. This group includes for example nurses including both visiting nurses and nurses in a hospital or care home setting, volunteers or family members. Upon scanning the unique product identifier the database can again provide information as to the genuine character of the product and if there are any outstanding product recalls. In case the cartridge is deemed counterfeit or under recall the App can provide information on how to have the cartridge either collected or safely disposed of. Furthermore the database can provide information on the safe administration of the insulin be it in the form of text, audio or visual content such as videos or an augmented reality (AR) display. In particular AR can be a useful tool as it is easily accessible to a user with for example an AR display explaining in 3D how the cartridge can be checked and used in a pen, where a user can see a 3D animation of a pen as it wraps around the “real” cartridge in front of their very eyes. In addition the system can provide the patient with information on diet or lifestyle changes in order to improve his quality of life or direct him to other goods or services related to diabetes. Companies that might provide goods or service that are of interest to a diabetes patient include for example restaurants and restaurant finders adapted to patients controlling their diet, food tracking apps and services adapted to diabetes patients targeting weight loss, fitness applications aiming to motivate diabetics to adhere to a healthy lifestyle, wearable fitness tracking devices, glucose monitoring applications, insulin calculators, diabetes care or help lines for patients and caregivers, dating sites for diabetics, travel agencies for diabetics, with specific inclusion of timetable changes of insulin administration, diabetes online discount stores, personalized coaching programs, physician/patient communication facilitators, patient/family communication facilitators or diabetes-specific social networks. It is also possible that the patient or caregiver App interacts with other Apps present on a smartphone such as food or fitness trackers in order to improve the patients quality of life.

In the above only stakeholders belonging to the value chain associated with the cartridge itself are considered. The “community” thus created can actually be enlarged to every stakeholder which has an interest to get in touch with people who are accessing the cartridge at one moment or another of its manufacturing, distribution or usage.

Furthermore the use of the method/system of the invention is of interest to the organization paying for the treatment as it will contribute to patient safety and cut down on the number of counterfeit drugs in the market. Furthermore it will provide them with a targeted communications channel with the patient which can be used to increase compliance and encourage positive diet and lifestyle choices to reduce the costs associated with problems and comorbidities associated with diabetes. In any case though the privacy of the patient remains protected as the method/system of the invention makes it possible to identify a user as belonging to a specific group without having to identify him as an individual user.

While the present invention has been described in connection with a number of select exemplary embodiments and implementations the present invention is not limited thereby but cover all modifications and equivalents falling within the scope and the spirit of the claims.

1. A method for selectively providing information to a targeted community of people, comprising the steps of:
a. choosing a community of people, said community of people comprising at least two persons;
b. identifying a product accessed by said community of people, said product comprising at least two product units;
c. providing at least one unique product identifier for each of said product units;
d. providing a database, said database comprising sets of information, said sets of information comprising at least two different units of information;
e. linking at least one of said sets of information to each of said unique product identifiers;
f. assigning each person in said community of people to at least one group to define at least two groups; and
g. providing each person with a reader, said reader being able to read said unique product identifier and comprising a request system for accessing said sets of information stored in said database based on said unique product identifier;
wherein each person is provided with a reader comprising a request system having a specific group identifier based on a membership to said at least one group and wherein at least one of said units of information is selectively provided to said person based on said unique product identifier and said specific group identifier.

2. The method of claim 1 wherein said database is stored on a computer system.

3. The method of claim 2, wherein said database is stored on a cloud system.

4. The method of claim 1 wherein said unique product identifier is provided in the form of at least one tag selected from the group consisting of barcodes, QR codes, Datamatrix codes, Zapcodes, RFID tags and NFC tags.

5. The method of claim 1 wherein said unique product identifier is incorporated into the packaging or product or is formed by at least a part of the packaging or product.

6. The method of claim 1 wherein said reader is selected from the group consisting of barcode scanners, camera equipped computers, scanner equipped computers, camera equipped PDAs, scanner equipped PDAs, camera equipped mobile telephones and scanner equipped mobile telephones.

7. The method of claim 6, wherein said mobile telephone is a smartphone.

8. The system of claim 7 wherein said request system is an application on said smartphone.

9. The method of claim 1, wherein different groups are associated with different points in the value chain of the product.

10. The method of claim 1, wherein said product is selected from the group consisting of medical devices, drug products, personal care products, nutritional supplements, nutraceuticals, functional foods and foodstuffs.

11. The method of claim 1, wherein at least one group consists of persons suffering from a disease or disorder.

12. The method of claim 11 wherein said disease or disorder is a chronic disease or disorder.

13. A system for selectively providing information to a targeted community of people, said system comprising,
at least one product said product comprising at least two product units, each of said product units being provided with at least one unique product identifier;
a database, said database comprising sets of information, said sets of information comprising at least two different units of information, at least one of said sets of information being linked to each of said unique product identifiers; and
at least two readers, said readers being able to read said unique product identifier and comprising a request system for accessing said sets of information stored in said database based on the unique product identifier,
wherein each reader comprises a request system having a specific group identifier based on a membership of a user to at least one group of two or more groups and wherein at least one of said units of information is selectively provided to said reader based on said unique product identifier and said specific group identifier.

14. The system of claim 13 wherein said database is stored on a computer system.

15. The system of claim 14, wherein said database is stored on a cloud system.

16. The system of claim 13 wherein said unique product identifier is provided in the form of at least one tag selected from the group consisting of barcodes, QR codes, Datamatrix codes, Zapcodes, RFID tags and NFC tags.

17. The system of claim 13 wherein said unique product identifier is incorporated into the packaging or product or is formed by at least a part of the packging or product.

18. The system of claim 13 wherein said reader is selected from the group consisting of barcode scanners, camera equipped computers, scanner equipped computers, camera equipped PDAs, scanner equipped PADs, camera equipped mobile telephones and scanner equipped mobile telephones.

19. The system of claim 18, wherein said mobile telephone is a smartphone.

20. The system of claim 19 wherein said request system is an application on said smartphone.
